(19) United States
(12) Patent Application Publication
(10) Pub. No.: US 2015/0372544 A1
(43) Pub. Date: Dec. 24, 2015

(54) Rotary Electric Machine

(71) Applicants: Norihisa IWASAKI, Tokyo (JP); Hirooki TOKOI, Tokyo (JP); Yuji ENOMOTO, Tokyo (JP)

(72) Inventors: Norihisa IWASAKI, Tokyo (JP); Hirooki TOKOI, Tokyo (JP); Yuji ENOMOTO, Tokyo (JP)

(73) Assignee: Hitachi, Ltd., Chiyoda-ku, Tokyo (JP)

(21) Appl. No.: 14/377,350

(22) PCT Filed: Feb. 17, 2012
(86) PCT No.: PCT/JP2012/053890

§ 371 Date: Aug. 7, 2014

(51) Int. Cl. H02K 1/18; H02K 5/08; H02K 3/30

(52) U.S. Cl. CPC H02K 1/18; H02K 3/30; H02K 5/08

(57) ABSTRACT

It is necessary to keep the positional relation between a stator and a housing for a long time, so the stator and housing must be fixed to each other with increased adhesive strength. Since this kind of rotary electric machine is a mass-produced product, the fixing method is demanded to be simple enough to be suitable for mass production. In order to meet this demand, in a rotary electric machine, for bonding and fixing the stator and the housing for covering the stator by synthetic resin, a plurality of projecting parts are formed on the inner circumference of the housing and synthetic resin is poured into between the stator and housing to bond and fix the stator and housing.

### TECHNICAL FIELD

The present invention relates to rotary electric machines and more particularly to rotary electric machines in which a stator and a housing covering it are fixed with synthetic resin.

### BACKGROUND ART

In axial gap type rotary electric machines, usually a stator has as many stator cores wound with coils as slots which are arranged in the circumferential direction and the stator cores including coils are integrally fixed to form the stator by resin molding.

However, since the simply molded synthetic resin is exposed, external stress might cause the synthetic resin to crack or break. Therefore, a metal housing of aluminum or the like has been used to cover the housing in order to prevent damage to the synthetic resin due to external stress.

An ordinary method of fixing the stator and housing is shrinkage fitting, but this method has the following problem: the inner circumference of the compressed housing and the stator are simply fixed by shrinkage fitting and if the synthetic resin deteriorates over time, a gap might be produced in the shrinkage-fit area and as a consequence, a tiny gap might be produced between the stator and housing, causing a problem that relative displacement or misalignment occurs between them. Therefore, a countermeasure to prevent such relative displacement or misalignment is needed.

In order to solve this problem, Japanese Patent Laid-Open No. 2006-254562 (PTL 1) proposes a technique that lock parts protruding from the inner circumference of the housing toward the molded synthetic resin are provided to position and fix them.

Also, Japanese Patent Laid-Open No. 2006-296140 (PTL 2) proposes a technique that uneven ring-shaped members in the inner circumference of the housing are combined to fix them. In PTL 1 and PTL 2, the projecting parts are horn-shaped.

### CITATION LIST

### Patent Literature

PTL 1: Japanese Patent Laid-Open No. 2006-254562

PTL 2: Japanese Patent Laid-Open No. 2006-296140

### SUMMARY OF INVENTION

### Technical Problem

In PTL1, the stator core is fixed in the housing by mold resin and the lock projections protruding from the housing inner surface into the mold resin restrict displacement of the stator core in the circumferential and axial directions. However, since the projecting parts on the housing inner surface are horn-shaped, they are manufactured by machining. Practically, for a mass-produced product, it is desirable to manufacture them by extruding or drawing an aluminum material.

Also, in PTL2, a support frame is located on the inner circumferential surface of the housing and the stator core is fixed on the support frame by mold resin. The outer circumferential side of the support frame to be fixed on the inner circumferential side of the housing is cylindrical and its portion to be fixed by resin mold is polygonal. Whereas the polygonal shape maintains fixing strength in the circumferential direction, there is no mention of fixing strength in the axial direction. Also, the support frame is mentioned as being integrally fixed on the housing through fixing means such as screws, but this leads to an increase in the number of manufacturing man-hours and this is not practical.

In rotary electric machines, it is necessary to keep the positional relation between the stator and housing for a long time, so the stator and housing must be fixed to each other with increased adhesive strength. In addition, since this kind of rotary electric machine is a mass-produced product, the fixing method is demanded to be simple enough to be suitable for mass production.

An object of the present invention is to provide a rotary electric machine which increases the strength of adhesion between the stator and housing and has a simple structure suitable for mass production.

### Solution to Problem

The present invention is characterized in that in a rotary electric machine, for bonding and fixing a stator and a housing for covering the stator with synthetic resin, a plurality of projecting parts are formed on the inner circumference of the housing and synthetic resin is poured into between the stator and housing to bond and fix the stator and housing.

### Advantageous Effects of Invention

According to the present invention, the structure is simple and the stator and housing are restricted from moving in the circumferential and axial directions by the projecting parts, thereby preventing relative displacement or misalignment between them.

### BRIEF DESCRIPTION OF DRAWINGS

FIG. 1 is a longitudinal sectional view of an axial gap type rotary electric machine according to one example of the present invention.

FIG. 2 is an external perspective view of a housing according to an example of the present invention.

FIG. 3A is an external perspective view of a housing according to another example of the present invention.

FIG. 3B is an external perspective view of the housing shown in FIG. 3A in which a stator is housed.

FIG. 4A is an external perspective view of a housing according to another example of the present invention.

FIG. 4B is an external perspective view of a pin-like projecting part shown in FIG. 4A.

FIG. 5 is an external perspective view of a housing according to another example of the present invention.

FIG. 6 is an external perspective view of a housing according to another example of the present invention.

FIG. 7A is an external perspective view of a housing according to another example of the present invention.

FIG. 7B is a sectional view of the housing shown in FIG. 7A in which a stator is housed.

FIG. 7C is a fragmentary sectional perspective view of the housing shown in FIG. 7B.

FIG. 8 is a longitudinal sectional view of an ordinary axial gap type rotary electric machine.

### DESCRIPTION OF EMBODIMENTS

First, prior to describing the present invention, the general structure of an axial gap type rotary electric machine as an example of a rotary electric machine and a problem related thereto are described below.

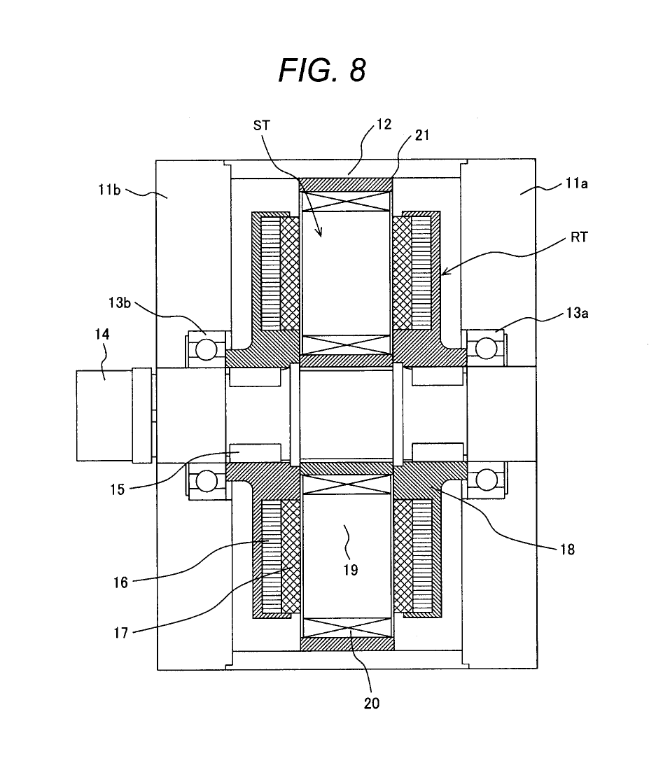

In FIG. 8, the chassis of an axial gap type rotary electric machine includes a rear bracket 11a, a cylindrical housing 12 for covering a stator which will be described later, and a front bracket 11b.

A shaft 14 protruding at the left end in the figure is a rotor shaft and the rotator shaft 14 is rotatably supported by a bearing 13a located on the inner circumference of the rear bracket 11a and a bearing 13b located on the inner circumference of the front bracket 11b.

A stator ST is located near the center of the rotor shaft 14 with a gap in a way not to touch the rotor shaft 14. The stator ST is comprised of a conductor coil 20 and a stator core 19 around which the conductor coil 20 is wound and the stator core 19 and conductor coil 20 are molded with synthetic resin and integrated into a resin molded portion 21.

The stator core 19 is made of a well-known material as a soft magnetic material such as iron, magnetic steel sheet, powder magnetic core, amorphous metal or permendur and for protection against eddy currents, it is desirable that the stator core 19 be a radially or circumferentially laminated core.

The stator core 19 and conductor coil 20 integrated by synthetic resin are fixed on the inner circumference of the housing 19 by the method described in PTL1 or PTL2.

A rotor RT is fixed on the rotor shaft 14 with a prescribed axial air gap with respect to the stator ST. The rotor RT includes a back core 16 made of a soft magnetic material such as iron, magnetic steel sheet, powder magnetic core, amorphous metal or permendur, permanent magnets 17 located circumferentially on the axial surface or inside of the back core, and a support member 18 for supporting the back core 16 and the permanent magnets 17.

The support member 18 is fixed on the rotor shaft 14 to transmit rotation of the rotor RT to the rotor shaft 14. When fixing the support member 18 on the rotor shaft 14, the existence of a keyway 15 facilitates positioning and prevents the support member 18 from moving in the circumferential direction. Alternatively they are joined using a spline or the like.

The permanent magnets 17, located circumferentially, are permanent magnets with their poles adjacent to each other and arranged so that the stator side poles and opposite side poles are alternately located in the axial direction.

If a permanent magnet 17 is to be fixed by being pasted onto the surface of the back core 16, this assembling work would be easy, but it is necessary to prevent the permanent magnet 17 from flying apart due to the centrifugal force generated by rotation of the support member 18 because the permanent magnet 17 is merely pasted onto the surface of the back core 16.

For this reason, usually the inner and outer circumferential sides of the permanent magnet 17 are covered by the support member 18 so as to prevent the permanent magnet 17 from moving and flying apart. When the permanent magnet 17 is housed in the back core 16, the permanent magnet 17 should be inserted in the axial direction of the back core 16 so that the inner and outer circumferential sides are covered by the housing wall of the back core 16. At this time, the permanent magnet 17 is located nearer to the stator ST than the back core 16 as seen in the axial direction.

When the permanent magnet 17 is inserted in the back core 16, the permanent magnet 17 is prevented from flying apart due to the centrifugal force generated by rotation of the support member 18 and at the same time the use of reluctance torque becomes possible in connection with saliency ratio.

The above rotary electric machine structure has been known and in this type of rotary electric machine, the positional relation between the stator and housing must be maintained for a long time and thus the stator and housing must be fixed to each other with increased strength of adhesion between them. Furthermore, since this type of rotary electric machine is a mass-produced product, the fixing method is demanded to be simple enough to be suitable for mass production.

Next, examples of a rotary electric machine according to the present invention which meets this demand will be described referring to drawings. The examples given below will be described on the assumption that the rotary electric machine is of the axial gap type but the same explanation is applicable to another type, for example, an ordinary radial type rotary electric machine.

### Example 1

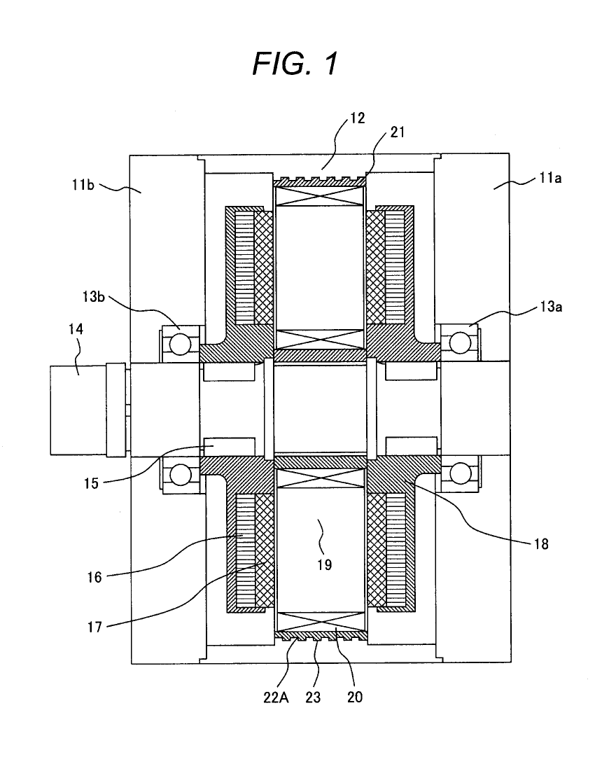

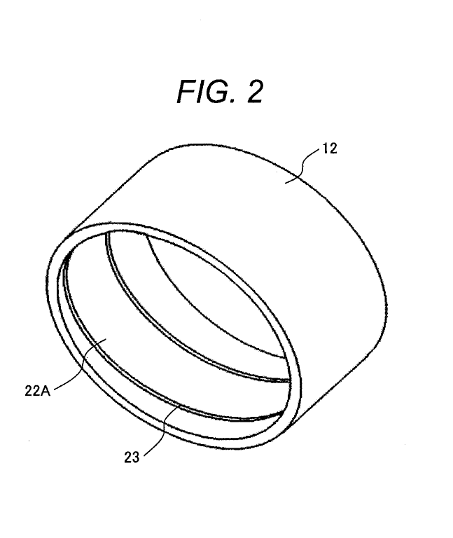

Next, a first example of the present invention will be described, referring to FIGS. 1 and 2. The rotary electric machine shown in FIG. 1 is structurally almost the same as the axial gap type rotary electric machine shown in FIG. 8 though they are different in the structure for fixing the housing 12 and stator ST. FIG. 2 shows the inner circumferential surface side of the housing 12 shown in FIG. 1 to be joined to the stator ST.

As shown in FIG. 2, a spiral projecting part 22A which runs in the axial direction of the housing 12 is provided on the inner circumferential surface of the housing 12. The spiral projecting part 22 is formed between spiral grooves 23; this spiral projecting part 22A may be integrated with the housing 12 by machining the inner circumferential surface of the housing 12 to make the spiral grooves 23 or by extrusion-molding a material rotating at a given speed. It should be noted that the pitch shown in FIG. 2 is larger than in FIG. 1.

Therefore, when synthetic resin is poured into between the housing 12 and stator ST to fix them, this spiral projecting part 22A has a function to restrict displacement in the circumferential and axial directions. In addition, the spiral projecting part 22A can increase the strength of adhesion between the stator ST and housing 12, thereby preventing displacement or misalignment between the stator ST and housing 12 in the axial and circumferential directions.

Regarding the shape of the spiral projecting part 22, as FIG. 1 indicates, when the pitch of the spiral projecting part 22A is smaller, the strength of adhesion between the stator ST and housing 12 is increased but the strength against the circumferential torque is decreased. Conversely, as FIG. 2 indicates, when the spiral pitch is larger, the strength of adhesion between the stator ST and housing 12 is decreased but the strength against the circumferential torque is increased. Therefore, the spiral shape and pitch should be appropriately designed according to the torque, rotation speed, etc. of the rotary electric machine.

Next the method of fixing the housing 12 and stator ST will be described. They are manufactured by a double-mold method as follows: first, the conductor coil 20 and stator core 19 are fixed in the resin molded portion 21 by synthetic resin such as epoxy resin to make up the stator ST and synthetic resin such as epoxy resin is poured into between the finished stator ST and housing 12 to fix them integrally. Alternatively, the conductor coil 20, stator core 19, and housing 12 may be combined so that simultaneously resin molding is performed by pouring synthetic resin to fix them integrally.

Here, in consideration of synthetic resin compatibility, it is desirable that the synthetic resin used to integrate the conductor coil 20 and stator core 19 be the same as the synthetic resin used to integrate the stator ST and housing 12.

### Example 2

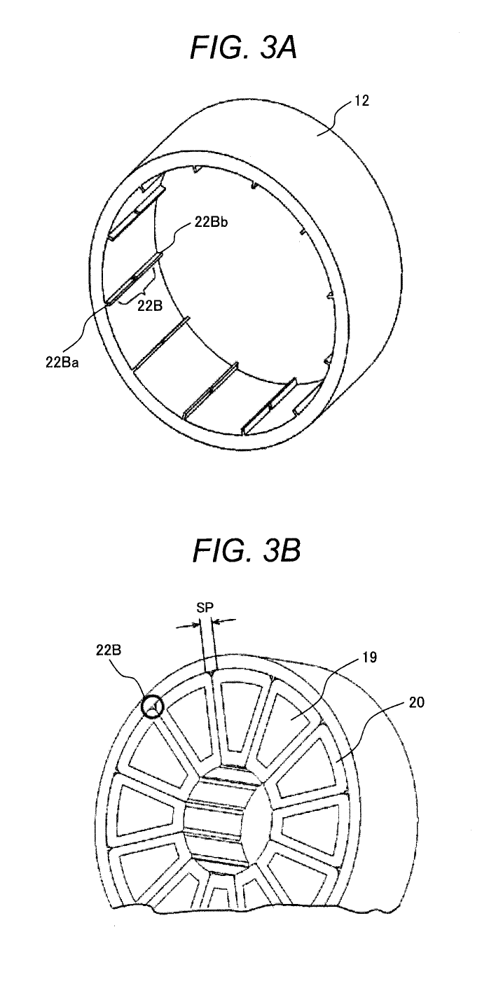

Next, a second example of the present invention will be described, referring to FIGS. 3A and 3B. FIG. 3A shows the inner circumferential surface side of the housing 12 shown in FIG. 1 to be joined to the stator ST.

Referring to FIG. 3A, projecting parts 22 are located on the inner circumferential surface of the housing 12 and as many such projecting parts 22 as the slots of pole pieces constituting the stator ST are arranged in the circumferential direction. One projecting part 22b extending in the axial direction of the housing 12 is divided into two parts of projecting parts 22Ba and 22Bb.

As shown in FIG. 3B, in the stator ST, a plurality of pole pieces, each comprised of a stator core 19 wound with a conductor coil 20, in the same quantity as the slots are arranged in the circumferential direction. Consequently, a gap SP is produced between adjacent conductor coils 20 on their outer side in the radial direction.

By assembling so as to make the projecting parts 22B shown in FIG. 3A fit the gaps SP, a vacant space between the housing 12 and stator ST can be effectively used. This minimizes the gap for resin molding and improves heat conduction from the conductor coils 20 to the housing 12, contributing to improvement in heat radiation performance.

Furthermore, since the projecting part 22B is located in the gap SP, the position of the projecting part 22B is more inward in the radial direction than the outermost position of the conductor coil 20, thereby contributing to improvement in heat radiation performance.

Thanks to the above improvement in heat radiation performance, heat-related loss can be reduced, leading to higher efficiency.

One projecting part 22B extending in the axial direction of the housing 12 is divided into two parts of projecting parts 22Ba and 22Bb, and synthetic resin goes into the area where they are divided, thereby providing a function to restrict displacement in the circumferential and axial directions.

The lengths of the four sides of the projecting part 22B and its height are varied and can be appropriately designed according to the torque of the rotary electric machine and the environment where it is installed.

The projecting parts 22B are formed integrally with the inner circumferential surface of the housing 12 by machining the inner circumferential surface of the housing 12.

Alternatively, the projecting parts 22 may be made of a material which is the same as or different from the material of the housing 12 and may be attached to the inner circumferential surface of the housing 12 using fixing means such as screws to integrate them.

As the resin molded portion 21 deteriorates over time due to heat or mechanical stress, a tiny gap might be produced between the inner circumferential surface of the housing 12 and the resin molded portion 21, causing displacement or misalignment between the stator ST and housing 12 in the axial and circumferential directions of the housing 12.

Particularly, a rotary torque is generated between the rotor RT and stator ST in the circumferential direction, so this torque is applied between the stator ST and housing 12. Therefore, the fixing strength between the housing 12 and the resin molded portion 21 is important because a force is applied to both of them.

According to this example, when synthetic resin is poured into between the housing 12 and stator ST to fix them, the strength of adhesion between the molded resin 21 of the stator ST and the inner circumference of the housing 12 is increased by the projecting parts 22B arranged in the circumferential and axial directions. Therefore, the projecting parts 22B on the inner circumferential side of the housing 12 prevent displacement or misalignment between the stator ST and housing 12 in the axial and circumferential directions.

Next the method of fixing the housing 12 and stator ST will be described. The following double-mold manufacturing method may be used: first, the conductor coil 20 and stator core 19 are fixed in the resin molded portion 21 by synthetic resin such as epoxy resin to make up the stator ST and synthetic resin such as epoxy resin is poured into between the finished stator ST and housing 12 to fix them integrally. Alternatively, the conductor coil 20, stator core 19, and housing 12 may be combined so that simultaneously resin molding is performed by pouring synthetic resin to fix them integrally.

Here, in consideration of synthetic resin compatibility, it is desirable that the synthetic resin used to integrate the conductor coil 20 and stator core 19 be the same as the synthetic resin used to integrate the stator ST and housing 12.

### Example 3

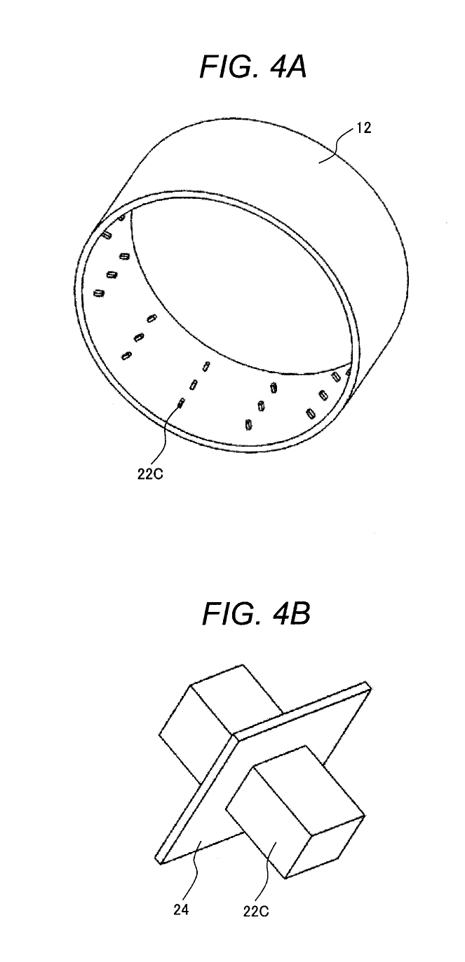

Next, a third example of the present invention will be described, referring to FIGS. 4A and 4B. FIG. 4A shows the inner circumferential surface side of the housing 12 shown in FIG. 1 to be joined to the stator ST.

Referring to FIG. 4A, a plurality of quadrangular prism pin-like projecting parts 22C are located on the inner circumferential surface of the substantially cylindrical housing 12. The pin-like projecting parts 22C are arranged at regular or irregular intervals in the circumferential direction and also at regular or irregular intervals in the radial direction.

This figure shows an example that they are arranged at regular intervals and the quadrangular prism of each pin-like projecting part 22C has sides which are perpendicular to the circumferential direction and perpendicular to the axial direction. Therefore, the pin-like projecting parts 22C provide a function to restrict displacement in the circumferential and axial directions.

The lengths of the four sides of the pin-like projecting part 22C and its height are varied and can be appropriately designed according to the torque of the rotary electric machine and the environment where it is installed.

When synthetic resin is poured into between the housing 12 and stator ST to fix them, the strength of adhesion between the stator ST and the housing 12 is increased by the pin-like projecting parts 22C arranged in the circumferential and axial directions, thereby preventing displacement or misalignment between the stator ST and housing 12 in in the axial and circumferential directions.

The pin-like projecting parts 22C are fixed by being inserted from the inner circumferential surface of the housing 12 outwards. If the pin-like projecting parts 22C to be inserted have a uniform shape in the longitudinal direction, non-penetrating housing holes extending from the inner circumferential surface of the housing 12 outwards can be made so that the pin-like projecting parts 22C are fixed by being inserted in these housing holes.

Alternatively, in order to simplify the manufacturing process, a pin-like projecting part 22C with a mounting plate 24 in the middle as shown in FIG. 4B may be prepared before the mounting plate 24 is attached to a penetrating hole made in the housing 12, by welding or a similar technique. As for where to insert the pin-like projecting part 22C, it is desirable to use the gap SP (see FIG. 3B) between conductor coils 20 as in the second example. By doing so, as in the second example, the gap for resin molding is minimized and heat conduction from the conductor coils 20 to the housing 12 is improved, thereby contributing to improvement in heat radiation performance. Furthermore, when the pin-like projecting part 22C is located in the gap SP, the position of the pin-like projecting part 22C is more inward in the radial direction than the outermost position of the conductor coil 20, thereby contributing to improvement in heat radiation performance. Thanks to the above improvement in heat radiation performance, heat-related loss can be reduced, leading to higher efficiency.

In order to suppress eddy currents more effectively, it is desirable that the pin-like projecting part 22C be located in the center of the housing 12 in its axial direction and the pin-like projecting part 22C be located near the center of the stator core 19 in its axial direction with respect to both end faces of the stator core 19. In other words, the pin-like projecting part 22C should be located away from the both end faces of the stator core 19. By doing so, a magnetic flux flowing from an end face of the stator core 19 is restricted from flowing to the pin-like projecting part 22C as a leakage flux, resulting in suppression of eddy currents flowing in the housing 12.

Although FIG. 4A shows three pin-like projecting parts 22C arranged in the axial direction, instead three pin-like projecting parts 22C may be formed continuously as if a single pin-like projecting part 22C were located on the inner circumferential surface portion of the housing 12 facing the stator ST, in the axial direction.

Next the method of fixing the housing 12 and stator ST will be described. They are manufactured by a double-mold method as follows: first, the conductor coil 20 and stator core 19 are fixed in the resin molded portion 21 by synthetic resin such as epoxy resin to make up the stator ST and synthetic resin such as epoxy resin is poured into between the finished stator ST and housing 12 to fix them integrally. Alternatively, the conductor coil 20, stator core 19, and housing 12 may be combined so that simultaneously resin molding is performed by pouring synthetic resin to fix them integrally.

Here, in consideration of synthetic resin compatibility, it is desirable that the synthetic resin used to integrate the conductor coil 20 and stator core 19 be the same as the synthetic resin used to integrate the stator ST and housing 12.

### Example 4

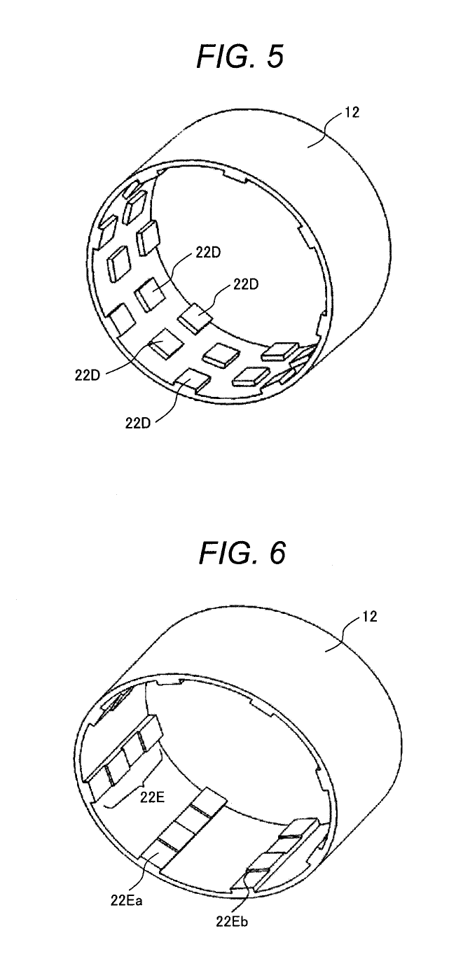

Next, a fourth example of the present invention will be described, referring to FIG. 5. FIG. 5 shows the inner circumferential surface side of the housing 12 shown in FIG. 1 to be joined to the stator ST.

A plurality of projecting parts 22D are located on the inner circumferential surface of the housing 12. The projecting parts 22D are arranged at regular or irregular intervals in the circumferential direction and also at regular or irregular intervals in the radial direction.

This figure shows an example that they are arranged at regular intervals and the projecting parts 22D are quadrangular. Each rectangular projecting part has sides which are perpendicular to the circumferential direction and perpendicular to the axial direction. Therefore, when the housing 12 and stator ST are fixed by pouring synthetic resin into between them, the projecting parts 22D provide a function to restrict displacement in the circumferential and axial directions.

The lengths of the four sides of the projecting part 22D and its height are varied and can be appropriately designed according to the torque of the rotary electric machine and the environment where it is installed.

The projecting parts 22D are formed integrally with the inner circumferential surface of the housing 12 by machining the inner circumferential surface of the housing 12 or by extrusion-molding a material which is being rotated and stopped repeatedly at a given speed. In the case of extrusion molding, the molding process becomes slightly gradual during the transition period between rotation and stop, so the corners of the finished projecting part 22D are rounded and thus the projecting part 22D is smoothly joined to the inner circumferential surface of the housing 12.

Alternatively, the projecting parts 22D may be made of a material which is the same as or different from the material of the housing 12 and attached to the inner circumferential surface of the housing 12 using fixing means such as screws to integrate them. The strength of adhesion between the molded resin 21 of the stator ST and the inner circumference of the housing 12 is increased by the projecting parts 22D arranged in the circumferential and axial directions.

As mentioned earlier, if the resin molded portion 21 deteriorates over time due to heat or mechanical stress, a tiny gap might be produced between the inner circumferential surface of the housing 12 and the resin molded portion 21, causing displacement or misalignment between the stator ST and housing 12 in the axial and circumferential directions of the housing 12.

Particularly, a rotary torque is generated between the rotor RT and stator ST in the circumferential direction and this torque is applied between the stator ST and housing 12. Therefore, the fixing strength between the housing 12 and the resin molded portion 21 is important because a force is applied to both of them. Therefore, the projecting parts 22D on the inner circumferential side of the housing 12 prevent displacement or misalignment between the stator ST and housing 12 in the axial and circumferential directions.

In this example, the length of the four sides of each projecting part 22D is larger than its height. In other words, the projecting part 22D has a flat shape in which its size along the inner circumferential surface of the housing 12 is larger than its height size. This enhances the effectiveness of preventing displacement or misalignment between the stator ST and housing 12 in the circumferential and axial directions and also eliminates the possibility that the diameter of the housing 12 is undesirably large, contributing to compactness of the machine.

In the housing 12, eddy currents occur due to leakage of a magnetic flux generated in the stator ST and such eddy currents may lead to deterioration in the efficiency of the rotary electric machine, so it is an important issue to reduce such eddy currents.

In this connection, in the fourth example, the quadrangular projecting parts 22D are arranged at intervals in the circumferential and axial directions, preferably with the projecting parts 22D lying across coils, so the distance from the housing inner circumferential surface between the protruding parts 22D to the stator core 19 is increased, resulting in suppression or reduction of eddy currents. It is thus expected that eddy currents in the housing 12 are suppressed and the efficiency of the rotary electric machine is improved.

For enhancement of the eddy current suppression effect, desirably the projecting part 22D should lie across coils and be located away from both end faces of the stator core 19 and near the center of the stator core 19 in the axial direction. By doing so, a magnetic flux flowing from an end face of the stator core 19 is restricted from flowing to the projecting part 22D as a leakage flux, resulting in suppression of eddy currents flowing in the housing 12.

In this connection, in order to increase the length of the four sides of the projecting part 22D, only one projecting part 22D should be located in the axial direction on the inner circumferential surface portion of the housing 12 facing the stator ST. An increase in the length of the four sides of the projecting part 22D enhances the effectiveness of preventing displacement or misalignment between the stator ST and housing 12 in the circumferential and axial directions and when only one projecting part 22D is located in the axial direction, it is easier to form the projecting parts 22D and mass-productivity of the housing 12 is enhanced.

Next the method of fixing the housing 12 and stator ST will be described. In the stator ST, the pole pieces of the stator cores 19 wound with conductor coils 20 are arranged in the circumferential direction as illustrated in FIG. 1 and integrally fixed by the resin molded portion 21.

Therefore, the following double-mold manufacturing method may be used: first, the conductor coil 20 and stator core 19 are fixed in the resin molded portion 21 by synthetic resin such as epoxy resin to make up the stator ST and synthetic resin such as epoxy resin is poured into between the finished stator ST and housing 12 to fix them integrally. Alternatively, the conductor coil 20, stator core 19, and housing 12 may be combined so that simultaneously resin molding is performed by pouring synthetic resin to fix them integrally.

Here, in consideration of synthetic resin compatibility, it is desirable that the synthetic resin used to integrate the conductor coil 20 and stator core 19 be the same as the synthetic resin used to integrate the stator ST and housing 12.

### Example 5

Next, a fifth example of the present invention will be described, referring to FIG. 6. FIG. 6 shows the inner circumferential surface side of the housing 12 shown in FIG. 1 to be joined to the stator ST.

As shown in FIG. 6, a plurality of projecting parts 22E including lower projecting parts 22Ea and higher projecting parts 22Eb connected in the axial direction are arranged on the inner circumferential side of the housing 12 in the circumferential direction.

The projecting parts 22E are arranged at regular or irregular intervals in the circumferential direction and this figure shows an example that they are arranged at regular intervals. The lower projecting parts 22Ea and higher projecting parts 22Eb should be alternately arranged in the axial direction at least one by one.

The lower projecting parts 22Ea and higher projecting parts 22Eb are quadrangular and the lower projecting parts 22Ea and higher projecting parts 22Eb each have sides which are perpendicular to the circumferential direction and perpendicular to the axial direction. Therefore, when the housing 12 and stator ST are fixed by pouring synthetic resin into between them, the projecting parts 22E provide a function to restrict displacement in the circumferential and axial directions.

The lengths of the four sides of the lower projecting parts 22Ea and higher projecting parts 22Eb and their heights are varied and can be appropriately designed according to the torque of the rotary electric machine and the environment where it is installed.

The lower projecting parts 22Ea and higher projecting parts 22Eb are formed integrally with the inner circumferential surface of the housing 12 by machining the inner circumferential surface of the housing 12.

Alternatively, the projecting parts 22E may be made of a material which is the same as or different from the material of the housing 12 and may be attached to the inner circumferential surface of the housing 12 using fixing means such as screws to integrate them. The strength of adhesion between the molded resin 21 of the stator ST and the inner circumference of the housing 12 is increased by the projecting parts 22 arranged in the circumferential and axial directions.

As mentioned earlier, if the resin molded portion 21 deteriorates over time due to heat or mechanical stress, a tiny gap might be produced between the inner circumferential surface of the housing 12 and the resin molded portion 21, causing displacement or misalignment between the stator ST and housing 12 in the axial and circumferential directions of the housing 12.

Particularly, a rotary torque is generated between the rotor RT and stator ST in the circumferential direction and this torque is applied between the stator ST and housing 12. Therefore, the fixing strength with between the housing 12 and the resin molded portion 21 is important because a force is applied to both of them. Therefore, the projecting parts 22E on the inner circumferential side of the housing 12 prevent displacement or misalignment between the stator ST and housing 12 in the axial and circumferential directions.

In this example, the lengths of the four sides of the projecting parts 22Ea and c22Eb are larger than the height of the projecting part 22Eb. In other words, the projecting parts 22E have a flat shape in which the size along the inner circumferential surface of the housing 12 is larger than the height size. This enhances the effectiveness of preventing displacement or misalignment between the stator ST and housing 12 in the circumferential and axial directions and also eliminates the possibility that the diameter of the housing 12 is undesirably large, contributing to compactness of the machine.

As mentioned earlier, in the housing 12, eddy currents occur due to the coils of the stator ST and such eddy currents may lead to deterioration in the efficiency of the rotary electric machine, so it is an important issue to reduce such eddy currents.

In this connection, in the fifth example, the quadrangular lower and higher projecting parts 22E are arranged at intervals in the circumferential direction, preferably with the projecting parts 22E lying across coils, so the distance from the housing inner circumferential surface between the coils to the stator core 19 is increased, resulting in suppression or reduction of eddy currents. It is thus expected that eddy currents in the housing 12 are suppressed and the efficiency of the rotary electric machine is improved.

For enhancement of the eddy current suppression effect, it is desirable that the higher projecting part 22Ed should lie across coils and be located away from both end faces of the stator core 19 and near the center of the stator core 19 in the axial direction. By doing so, a magnetic flux flowing from an end face of the stator core 19 is restricted from flowing as a leakage flux to the projecting part 22Ed, resulting in suppression of eddy current flowing in the housing 12.

In this connection, in order to increase the length of the four sides of the projecting part 22E, only one projecting part 22E should be located in the axial direction on the inner circumferential surface portion of the housing 12 facing the stator ST. An increase in the length of the four sides of the projecting part 22E enhances the effectiveness of preventing displacement or misalignment between the stator ST and housing 12 in the circumferential and axial directions and when only one projecting part 22E is located in the axial direction, it is easier to form the projecting parts 22E and mass-productivity of the housing 12 is enhanced.

Next the method of fixing the housing 12 and stator ST will be described. The following double-mold manufacturing method is used: first, the conductor coil 20 and stator core 19 are fixed in the resin molded portion 21 by synthetic resin such as epoxy resin to make up the stator ST and synthetic resin such as epoxy resin is poured into between the finished stator ST and housing 12 to fix them integrally. Alternatively, the conductor coil 20, stator core 19, and housing 12 may be combined so that simultaneously resin molding is performed by pouring synthetic resin to fix them integrally.

Here, in consideration of synthetic resin compatibility, it is desirable that the synthetic resin used to integrate the conductor coil 20 and stator core 19 be the same as the synthetic resin used to integrate the stator ST and housing 12.

### Example 6

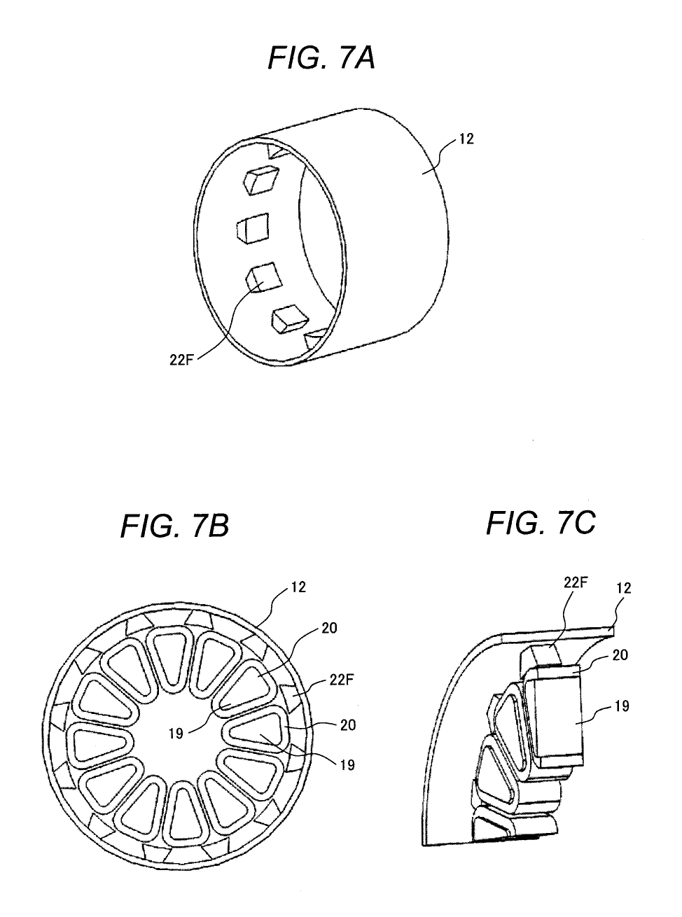

Next, a sixth example of the present invention will be described, referring to FIGS. 7A, 7B, and 7C. FIG. 7A shows the inner circumferential surface side of the housing 12 shown in FIG. 1.

A plurality of projecting parts 22F are located in a way to protrude near the center of the inner circumferential side of the housing 12 and preferably the projecting parts 22F are arranged in a row in the circumferential direction and at regular intervals. Each projecting part 22F has a truncated pyramid shape and its axial cross section is quadrangular and its radial cross section is trapezoidal. It is a truncated pyramid in which its bottom side (portion to be joined to the housing 12) is shorter than its top side.

The truncated pyramid-shaped projecting part 22F has sides which are perpendicular to the circumferential direction and perpendicular to the axial direction. Therefore, when the housing 12 and stator ST are fixed by pouring synthetic resin into between them, the projecting parts 22F provide a function to restrict displacement in the circumferential and axial directions.

The lengths of the four sides of the projecting part 22F and its height are varied and can be appropriately designed according to the torque of the rotary electric machine and the environment where it is installed.

The projecting parts 22F are formed integrally with the inner circumferential surface of the housing 12 by machining the inner circumferential surface of the housing 22.

Alternatively, the projecting parts 22F may be made of a material which is the same as or different from the material of the housing 12 and attached to the inner circumferential surface of the housing 12 using fixing means such as screws to integrate them. The strength of adhesion between the resin molded portion 21 of the stator ST and the inner circumference of the housing 12 is increased by the projecting parts 22F arranged in the circumferential and axial directions.

As mentioned earlier, if the resin molded portion 21 deteriorates over time due to heat or mechanical stress, a tiny gap might be produced between the inner circumferential surface of the housing 12 and the resin molded portion 21, causing displacement or misalignment between the stator ST and housing 12 in the axial and circumferential directions of the housing 12.

Particularly, a rotary torque is generated between the rotor RT and stator ST in the circumferential direction and this torque is applied between the stator ST and housing 12. Therefore, the fixing strength between the housing 12 and the resin molded portion 21 is important because a force is applied to both of them. Therefore, the projecting parts 22F on the inner circumferential side of the housing 12 prevent displacement or misalignment between the stator ST and housing 12 in the axial and circumferential directions.

In this example, the lengths of the four sides (at least the lengths of the four sides of the top surface) of each projecting part 22F are larger than its height. In other words, the projecting part has a flat shape in which its size along the inner circumferential surface of the housing 12 is larger than its height size. This enhances the effectiveness of preventing displacement or misalignment between the stator ST and housing 12 in the circumferential and axial directions and also eliminates the possibility that the diameter of the housing 12 is undesirably large, contributing to compactness of the machine.

In the housing 12, eddy currents occur due to the individual conductor coils of the stator ST and such eddy currents may lead to deterioration in the efficiency of the rotary electric machine, so it is an important issue to reduce such eddy currents.

In this connection, in the sixth example, as shown in FIGS. 7B and 7C, as many truncated pyramid-shaped projecting parts 22F as the stator cores 19 are arranged at regular intervals in the circumferential direction, lying across adjacent coils 20. Therefore, the distance from the housing inner circumferential surface between projecting parts 22F to the stator core 19 is increased, resulting in suppression or reduction of eddy currents. It is thus expected that eddy currents in the housing 12 are suppressed and the efficiency of the rotary electric machine is improved.

For enhancement of the eddy current suppression effect, desirably the projecting part 22F should lie across coils and be located away from both end faces of the stator core 19 and near the center of the stator core 19 in the axial direction. By doing so, a magnetic flux flowing from an end face of the stator core 19 is restricted from flowing to the projecting part 22F as a leakage flux, resulting in suppression of eddy current flowing in the housing 12.

In this connection, in order to increase the length of the four sides of the projecting part 22F, only one projecting part 22F should be located in the axial direction on the inner circumferential surface portion of the housing 12 facing the stator ST. An increase in the length of the four sides of the projecting part 22F enhances the effectiveness of preventing displacement or misalignment between the stator ST and housing 12 in the circumferential and axial directions and when only one projecting part 22F is located in the axial direction, it is easier to form the projecting parts 22F and mass-productivity of the housing 12 is enhanced.

Next the method of fixing the housing 12 and stator ST will be described. In the stator ST, the pole pieces of the stator cores 19 wound with conductor coils 20 are arranged in the circumferential direction as shown in FIG. 7 and integrally fixed by the resin molded portion 21.

Therefore, the following double-mold manufacturing method is used: first, the conductor coil 20 and stator core 19 are fixed in the resin molded portion 21 by synthetic resin such as epoxy resin to make up the stator ST and synthetic resin such as epoxy resin is poured into between the finished stator ST and housing 12 to fix them integrally. Alternatively, the conductor coil 20, stator core 19, and housing 12 may be combined so that simultaneously resin molding is performed by pouring synthetic resin to fix them integrally.

Here, in consideration of synthetic resin compatibility, it is desirable that the synthetic resin used to integrate the conductor coil 20 and stator core 19 be the same as the synthetic resin used to integrate the stator ST and housing 12.

In the above examples, the rotor RT and stator ST are located in the monolithic housing 12 comprised of a single member. Here the rotor RT is located on each side of the stator ST in the axial direction of the stator ST. When the housing 12 which contain the rotors RT and stator ST as mentioned above are structured according to the above examples, the housing 12 and rotary electric machine can be produced with high mass-productivity.

Furthermore, in the second to sixth examples (in the case of the third example, a variation thereof), at least the height size of the projecting part is smaller than their axial length size (the axial length size is larger than the height size), which prevents displacement or misalignment between the stator ST and housing 12 in the circumferential and axial directions and also eliminates the possibility that the diameter of the housing 12 is undesirably large, contributing to compactness of the machine. Even when the height size is smaller than their axial and circumferential length sizes, namely the axial and circumferential length sizes are larger than the height size, the same advantageous effect as above is brought about.

Also, by adjusting the circumferential size appropriately, namely by adjusting the circumferential size so that a projecting part fits in a gap SP between adjacent assemblies each including a stator core 19 and a conductor coil 20, the projecting part can also be located in the gap SP in the fourth to sixth examples. In this case, as the stator core 19 is nearer to the inner circumferential surface of the housing 12, the eddy current suppression effect is smaller. The gap SP is produced mainly by the curved (radius) portions produced by bending the conductor coils 20, so the curved portions can be appropriately shaped in consideration of the arrangement of the projecting parts.

### REFERENCE SIGNS LIST

11a . . . rear bracket,
11b . . . front bracket,
12 . . . housing,
13a . . . rear bracket bearing,
13b . . . front bracket bearing,
14 . . . rotary shaft,
15 . . . keyway,
16 . . . back core,
17 . . . permanent magnet,
18 . . . support member,
19 . . . stator core,
20 . . . conductor coil,
21 . . . resin molded portion,
22A to 22F . . . projecting part,
23 . . . spiral groove

1.-19. (canceled)

20. A rotary electric machine having at least a rotor and a stator, in which a plurality of stator cores and conductor coils wound thereon to make up the stator are integrally fixed by synthetic resin, and synthetic resin is poured into between a metal housing covering the stator and the stator to fix the stator and the housing integrally,
wherein on an inner circumferential surface of the housing to be fixed to the stator, a projecting part protruding from the inner circumferential surface of the housing is provided; and
wherein the projecting part has a height size smaller than an axial size.

21. The rotary electric machine according to claim 20, wherein both ends in the axial direction are located at an axial center side with respect to both axial ends of the stator core.

22. The rotary electric machine according to claim 21, wherein as for the projecting part, only one projecting part is located on the housing inner circumferential surface of the facing the stator in an axial direction.

23. The rotary electric machine according to claim 22, wherein the projecting part is located between two adjacent assemblies each including a conductor core and a stator core and an innermost part of the projecting part is located nearer to a center than outermost parts of the assemblies.

24. The rotary electric machine according to claim 20, wherein the projecting part is provided in plurality in a circumferential direction and has a truncated quadrangular pyramid shape and a bottom side thereof to be joined to the inner circumferential surface of the housing is smaller in size.

25. The rotary electric machine according to claim 24, wherein the projecting part is located on the inner circumferential surface of the housing, lying across the adjacent conductor coils.

26. The rotary electric machine according to claim 25, wherein as many of the projecting parts as the stator cores are located on the inner circumferential surface of the housing.

27. The rotary electric machine according to claim 26, wherein opposite sides of a quadrangular shape of the projecting part and the other opposite sides protrude from the inner circumferential surface of the housing, parallel in circumferential and axial directions respectively.

28. The rotary electric machine according to claim 20, wherein the projecting parts are located in plurality in an axial direction as well.

29. The rotary electric machine according to claim 20, wherein the projecting parts are quadrangular projecting parts and arranged at regular intervals or irregular intervals on the inner circumferential surface of the housing in the circumferential direction.

30. The rotary electric machine according to claim 29, wherein the projecting parts are quadrangular projecting parts and arranged at regular intervals on the inner circumferential surface of the housing, parallel in the circumferential direction and lie across the conductor coils.

31. The rotary electric machine according to claim 30, wherein as many of the projecting parts as the conductor coils are located.

32. The rotary electric machine according to claim 29, wherein the projecting parts are quadrangular projecting parts and arranged at regular intervals or irregular intervals on the inner circumferential surface of the housing in the circumferential direction and have higher portions and lower portions in an axial direction.

33. The rotary electric machine according to claim 20, wherein an axially divided projecting part is located between the adjacent conductor coils of the stator on the inner circumferential surface of the housing.

34. The rotary electric machine according to claim 20, wherein mounting holes are arranged at regular intervals or irregular intervals on the inner circumferential surface of the housing in the circumferential and axial directions and pin-like projecting parts made separately from the housing are fitted into the mounting holes.
